(19) United States
(12) Patent Application Publication
(10) Pub. No.: US 2025/0387680 A1
(43) Pub. Date: Dec. 25, 2025

(54) GOLF SHAFT AND METHOD OF MANUFACTURING THE SAME

(71) Applicant: NHK SPRING CO., LTD., Kanagawa (JP)

(72) Inventors: Yuto MIYAKE, Yokohama-shi (JP); Kosuke FUJIWARA, Yokohama-shi (JP)

(73) Assignee: NHK SPRING CO., LTD., Kanagawa (JP)

(21) Appl. No.: 19/244,625

(22) Filed: Jun. 20, 2025

(30) Foreign Application Priority Data
Jun. 25, 2024 (JP) 2024-102082

(51) Int. Cl. A63B 53/12; A63B 102/32; B23C 3/00

(52) U.S. Cl. CPC A63B 53/12; B23C 3/002; A63B 2102/32

(57) ABSTRACT

A golf shat has a tip end portion, a butt end portion, an intermediate portion defined between respective longitudinal ends adjoining to the tip end portion and the butt end portion, wherein the intermediate portion is sectioned into a first portion and a second portion, the first portion is formed greater than a reducing trend in the wall thickness to cause an upward projection in a distribution curve of a bending rigidity, and the second portion is located axially adjoining to the first portion between the first portion and the butt end portion and is formed smaller than the reducing trend in the wall thickness to cause a downward projection in the distribution curve of the bending rigidity.

### BACKGROUND OF THE INVENTION

### 1. Field of the Invention

The present invention relates to a golf shaft to increase speed of a hit ball and a method of manufacturing the same.

### 2. Description of the Related Art

A conventional golf shaft is disclosed in JP2005-152613A, for example. The golf shaft has a tip-side front end for mounting a head thereon and a butt-side rear end for mounting a grip thereon. The golf shaft has bending rigidity distribution stretching the full length thereof and including maximum points, the maximum points having values in bending rigidity that are larger than values in bending rigidity of respective adjoining sections on the butt side. Then, the golf shaft has portions lowered in bending rigidity in the respective sections between the maximum points.

With this, the technique of JP2005-152613A provides smoothly entirely bending of the golf shaft like a whip without locally bending thereof. As this result, a player is allowed to swing naturally without incongruity feeling, thereby to increase speed of a head and carry of a hit ball.

The conventional golf shaft is, however, limited on increasing speed of the hit ball.

### SUMMARY OF THE INVENTION

An object of the present invention is to provide a golf shaft capable of increasing speed of a hit ball according to bending of the golf shaft.

In order to accomplish the object, a first aspect of the present invention provides a golf shaft having a tip end portion for attaching a head thereto, a butt end portion for attaching a grip thereto, and an intermediate portion defined between respective ends of the intermediate portion axially adjoining to the tip end portion and the butt end portion, having steps gradually increasing in an outer diameter from the end adjoining to the tip end portion to the end adjoining to the butt end portion and having wall thickness gradually reduced according to the increasing in the outer diameter of the steps. The intermediate portion is sectioned into a first portion and a second portion, the first portion is formed greater than a reducing trend of the intermediate portion in the wall thickness to cause an upward projection in a distribution curve of bending rigidity, and the second portion is located axially adjoining to the first portion between the first portion and the butt end portion and is formed smaller than the reducing trend in the wall thickness to cause a downward projection in the distribution curve of the bending rigidity.

Further, a second aspect of the present invention provides a method of manufacturing a golf shaft. The method of manufacturing the golf shaft performs a thickness deviation process to an element tube made of metal so that an intermediate portion of the element tube has a thick portion and thin portions on both axial sides of the thick portion, and performs a stepping process to the element tube having the thick portion and the thin portions according to the wall thickness, thereby forming steps gradually increasing in the outer diameter.

The first and the second aspects of the present invention provide a golf shaft capable of increasing speed of a hit ball according to bending of the golf shaft.

### BRIEF DESCRIPTION OF THE DRAWINGS

FIG. 1 is a general view illustrating an appearance of a golf club according to an embodiment of the present invention;

FIG. 2 is a schematic sectional view of a golf shaft used in the golf club of FIG. 1;

FIG. 3 is a schematic enlarged view illustrating an appearance of the golf shaft used in the golf club of FIG. 1;

FIG. 4 is a graph illustrating a distribution curve of an outer diameter of the golf shaft of FIG. 3 as well as a distribution curve of an outer diameter of a golf shaft of a comparative example;

FIG. 5 is a graph illustrating a distribution curve of bending rigidity of the golf shaft of FIG. 3 as well as a distribution curve of bending rigidity of a golf shaft of a comparative example without thickness deviation process;

FIG. 6 is a graph illustrating a distribution curve of wall thickness of the golf shaft of FIG. 3 as well as a distribution curve of wall thickness of a golf shaft of a comparative example without thickness deviation process;

FIG. 7 is a graph illustrating a relation between the distribution curve of the outer diameter and the steps of the golf shaft of FIG. 3;

FIG. 8 is a sectional view illustrating an element tube subjected to a thickness deviation process in a method of manufacturing the golf shaft according to the embodiment;

FIG. 9A is a side view illustrating a head and periphery thereof just before impacting a ball, FIG. 9B is a side view illustrating the same at the time of the impacting and FIG. 9C is a side view illustrating the same just after the impacting;

FIG. 10A is a side view illustrating a golf club according to a comparative example having one bending portion at the time of a downswing and just before impacting a ball and FIG. 10B is a side view illustrating a golf club having two bending portions at the time of a downswing and just before impacting a ball;

FIG. 11A is a side view illustrating a golf club with no hardened portion in an intermediate portion at an initial stage and a middle stage of a downswing and FIG. 11B is a side view illustrating a golf club with a hardened portion in an intermediate portion at an initial stage and a middle stage of a downswing;

FIG. 12A is a side view illustrating a golf club with a soft tip end portion at the time of impacting a ball and FIG. 12B is a side view illustrating a golf club with a hard tip end portion at the time of impacting a ball;

FIG. 13A is a side view illustrating a sample 1 of the golf shaft according to the embodiment and FIG. 13B is a sectional view illustrating wall thickness of the sample 1 of the same;

FIG. 14A is a side view illustrating a sample 2 of the golf shaft according to the embodiment and FIG. 14B is a sectional view illustrating wall thickness of the sample 2 of the same;

FIG. 15A is a side view illustrating a sample 3 of the golf shaft according to the embodiment and FIG. 15B is a sectional view illustrating wall thickness of the sample 3 of the same;

FIG. 16A is a side view illustrating a sample 4 of the golf shaft according to the embodiment and FIG. 16B is a sectional view illustrating wall thickness of the sample 4 of the same;

FIG. 17 is a graph illustrating a distribution curve of the bending rigidity of the sample 1 of FIG. 13;

FIG. 18 is a graph illustrating a distribution curve of the bending rigidity of the sample 2 of FIG. 14;

FIG. 19 is a graph illustrating a distribution curve of the bending rigidity of the sample 3 of FIG. 15;

FIG. 20 is a graph illustrating a distribution curve of the bending rigidity of the sample 4 of FIG. 16;

FIG. 21 is a table illustrating specifications of samples of the golf shafts according to the embodiment and the comparative example;

FIG. 22 is a graph illustrating distribution curves of the bending rigidity of the samples of the golf shafts according to the embodiment and the comparative example; and

FIG. 23 is a table illustrating results of trial hittings using the golf shafts according to the embodiment and the comparative example.

### DETAILED DESCRIPTION OF EMBODIMENTS

A golf shaft 3 of an embodiment is provided with a tip end portion 9, a butt end portion 11 and an intermediate portion 13. The tip end portion 9 is a region for attaching a head 5 thereto. The butt end portion 11 is a region for attaching a grip 7 thereto. The intermediate portion 13 is defined between respective ends of the intermediate portion 13 axially adjoining to the tip end portion 9 and the butt end portion 11. The intermediate portion 13 has steps S1-S11 gradually increasing in an outer diameter from the end adjoining to the tip end portion 9 to the end adjoining to the butt end portion 11 and has wall thickness gradually reduced according to or inversely proportional to the increasing in the outer diameter of the steps S1-S11. The intermediate portion 13 is sectioned into a first portion R1 and a second portion E1.

The first portion R1 is formed greater than a reducing trend of the intermediate portion 13 in the wall thickness. The first portion R1 causes an upward projection in a distribution curve of bending rigidity, the distribution curve of the bending rigidity spanning from the tip end portion 9 to the butt end portion 11. The second portion E1 is located axially adjoining to the first portion R1 between the first portion R1 and the butt end portion 11 and is formed smaller than the reducing trend in the wall thickness. A step S3 in the second portion E1 is preferably axially shorter than a step S4-S6. The second portion E1 causes a downward projection in the distribution curve of the bending rigidity.

A difference in the outer diameter between adjacent steps S4-S6 in the first portion R1 may be smaller than a difference in the outer diameter between adjacent steps S3 in the second portion E1.

The intermediate portion 13 of the golf shaft 3 may have a third portion E2. The third portion E2 is located axially adjoining to the first portion R1 between the first portion R1 and the tip end portion 9 and is formed smaller than the reducing trend in the wall thickness. The third portion E2 causes a downward projection in the distribution curve of the bending rigidity. The steps S7-S11 of the third portion E2 are preferably shorter than the steps S4-S6 of the first portion R1.

The third portion E2 may cause a flat portion F in the distribution curve of the bending rigidity, the flat portion transitioning with a fixed value in the bending rigidity toward the butt end portion 11.

Further, the golf shaft 3 may have a fourth portion R2. The fourth portion R2 is sectioned to be located on a side close to the tip end portion 9 relative to the third portion E2 and entirely be greater than the third portion E2 in the bending rigidity.

A method of manufacturing the golf shaft 3 performs a thickness deviation process to an element tube 20 made of metal so that an intermediate portion 13 of the element tube 20 has a thick portion 25a and thin portions 24a and 24b on both axial sides of the thick portion 25a. Next, a stepping process is performed to the element tube 20 having the thick portion 25a and the thin portions 24a and 24b according to the wall thickness, thereby forming the steps S1-S11 gradually increasing in the outer diameter. The stepping process preferably makes the steps S1-S11 at the thick portion 25a relatively axially long and the steps S1-S11 at the thin portions 24a and 24b relatively axially short.

Hereinafter, the embodiment of the present invention will be explained in detail with reference to the drawings.

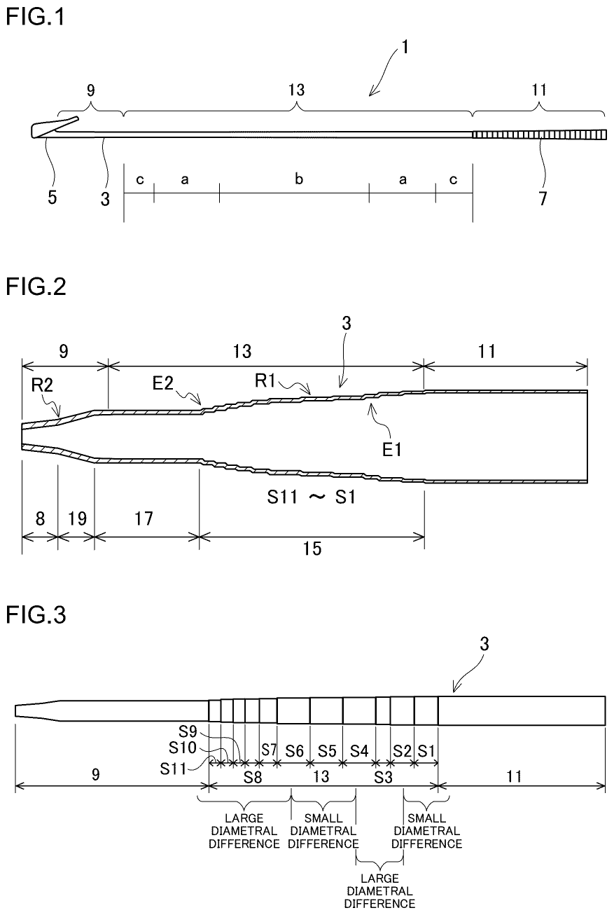

FIG. 1 is a general view illustrating an appearance of a golf club according to the embodiment of the present invention.

A golf club 1 has a golf shaft 3 to which a head 5 and a grip 7 are attached. The golf shaft 3 has a tip end portion 9, a butt end portion 11 and an intermediate portion 13. The tip end portion 9 is a region for attaching the head 5 thereto, and the butt end portion 11 is a region for attaching the grip 7 thereto. The intermediate portion 13 is a region located between the tip end portion 9 and the butt end portion 11.

In the intermediate portion 13, bending portions a are provided. Although two bending portions a are provided in FIG. 1, one bending portion or three or more bending portions may be provided. Further, the intermediate portion 13 has unbending portions b and c axially adjoining to the bending portions a.

The bending portions a are relatively soft portions of the golf shaft 3 and the unbending portions b and c are relatively hard portions of the golf shaft 3. The bending portions a and the unbending portions b and c are set by an outer diameter and wall thickness of the golf shaft 3 as explained later.

It should be noted that the unbending portions b and c are not portions to be never bent and are portions hard to be bent relatively to the bending portions a. The bending portions a are, therefore, bendable easily relatively to the unbending portions b and c.

FIG. 2 is a schematic sectional view of the golf shaft used in the golf club of FIG. 1.

As illustrated in FIGS. 1 and 2, the tip end portion 9 is a tip end portion of the golf shaft 3 in a longitudinal direction or an axial direction and is a region extending from a tip end of the golf shaft 3 with a predetermined range to attach the head 5 thereto. A length of the tip end portion 9 of the present embodiment is appropriately set within approximate 160 mm. The tip end portion 9 of the present embodiment includes an insertion portion 8, a tapered portion 19 and a part of a straight portion 17.

The insertion portion 8 is a portion to be inserted into the head 5 and is formed into a tapered shape gradually increasing in the outer diameter toward the butt end portion 11 of the golf shaft 3. The tip end portion 9, however, may be formed into a straight tube shape with a fixed outer diameter. The tapered portion 19 is axially adjoining to a base end of the insertion portion 8 and is formed into a tapered shape having a taper ratio greater than a taper ratio of the insertion portion 8. The base end of the insertion portion 8 is one of axial ends of the insertion portion 8 distal to the tip end of the golf shaft 3. The straight portion 17 is adjoining to a base end of the tapered portion 19 and has a fixed outer diameter. The base end of the tapered portion 19 is one of axial ends of the tapered portion 19 distal to the tip end of the golf shaft 3. It should be noted that the tip end portion 9 may be composed of the insertion portion 8 only. Further, the tip end portion 9 may be entirely formed into a straight shape.

The butt end portion 11 is a butt end portion of the golf shaft 3 in the longitudinal direction and is a region extending from a butt end of the golf shaft 3 with a predetermined range to attach the grip 7 thereto. A length of the butt end portion 11 of the present embodiment is appropriately set within approximate 300 mm. Although the butt end portion 11 is formed into a straight tube shape with a fixed outer diameter in the present embodiment, the butt end portion 11 may be formed into, for example, a tapered shape slightly altered in the outer diameter toward the butt end.

The intermediate portion 13 is located between the tip end portion 9 and the butt end portion 11 and has a front end adjoining to the tip end portion 9 and a base end adjoining to the butt end portion 11. Namely, the intermediate portion 13 is defined between the respective ends of the intermediate portion 13 axially adjoining to the tip end portion 9 and the butt end portion 11. A length of the intermediate portion 13 of the present embodiment is appropriately set within approximate 750 mm. The intermediate portion 13 has steps S1-S11 gradually increasing in the outer diameter from the front end to the base end thereof and has wall thickness gradually reduced according to or inversely proportional to the increasing in the outer diameter of the steps S1-S11.

The reduction of the wall thickness of the intermediate portion 13 means reduction by a reducing amount of the wall thickness according to or inversely proportional to an increasing amount of the outer diameter and excludes increase or reduction of the wall thickness at a first portion R1, a second portion E1 and a third portion E2 explained later.

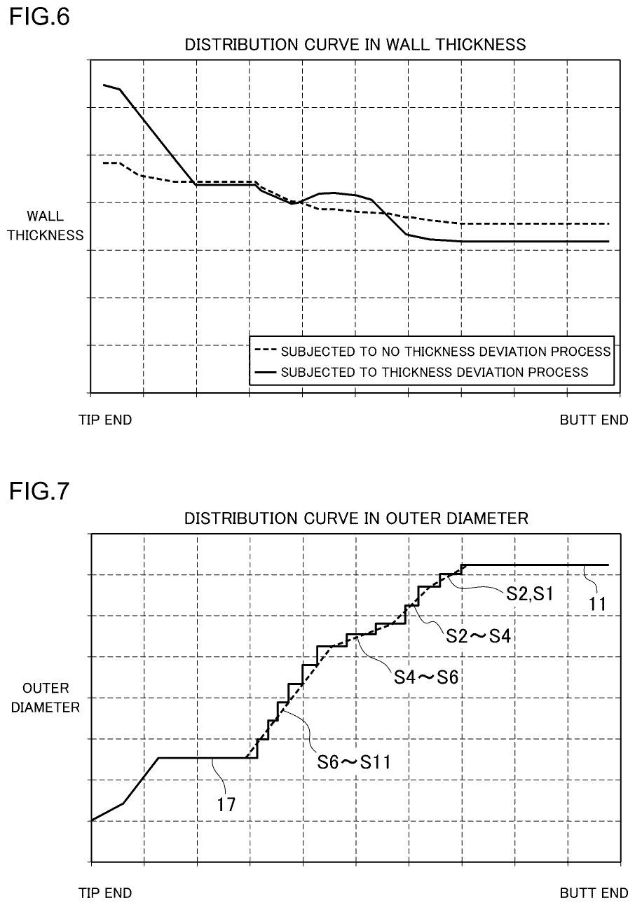

The reduction of the wall thickness of the intermediate portion 13 has a constant reducing trend in a distribution curve of the wall thickness and may be a reduction in a case that the base end of the tip end portion 9 and the front end of the butt end portion 11 are connected using steps in which each step has a fixed length and adjacent steps have a fixed difference in the outer diameter (see comparative example of FIG. 6), for example. The reducing trend of the wall thickness may be exhibited on a straight line in the distribution curve of the wall thickness connecting the base end of the tip end portion 9 and the front end of the butt end portion 11.

The intermediate portion 13 includes a remaining part of the straight portion 17 and a stepped portion 15.

The part of the straight portion 17 included in the intermediate portion 13 is longer than the part of the straight portion 17 included in the tip end portion 9 in the present embodiment. The straight portion 17 in the intermediate portion 13, however, may be set appropriately. The stepped portion 15 is axially adjoining to a base end of the straight portion 17. The stepped portion 15 is composed of the steps S1-S11.

The intermediate portion 13 is sectioned into the first portion R1, the second portion E1 and the third portion E2 according to the setting of the outer diameter and the wall thickness of the golf shaft 3.

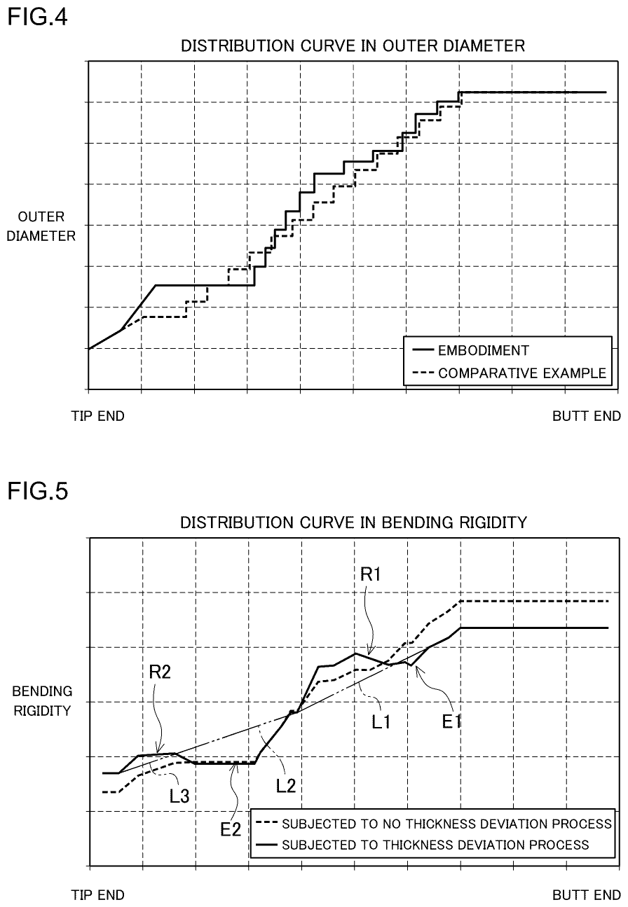

FIG. 3 is a schematic enlarged view illustrating an appearance of the golf shaft used in the golf club of FIG. 1. FIG. 4 is a graph illustrating a distribution curve of an outer diameter of the golf shaft of FIG. 3 as well as a distribution curve of an outer diameter of a golf shaft of a comparative example. FIG. 5 is a graph illustrating a distribution curve of bending rigidity of the golf shaft of FIG. 3 as well as a distribution curve of bending rigidity of a golf shaft of a comparative example without thickness deviation process. FIG. 6 is a graph illustrating a distribution curve of wall thickness of the golf shaft of FIG. 3 as well as a distribution curve of wall thickness of a golf shaft of a comparative example without thickness deviation process. FIG. 7 is a graph illustrating a relation between the distribution curve of the outer diameter and the steps of the golf shaft of FIG. 3. In addition, FIG. 2 and FIG. 3 are not identical with each other in shape and schematically illustrates the same structure.

As illustrated in FIGS. 3-7, the first portion R1 is formed greater than the reducing trend (see comparative example of FIG. 6) in the wall thickness in the intermediate portion 13 and the steps in the first portion R1 are axially relatively long (by comparison with the steps in the second portion E1). According to the present embodiment, the first portion R1 is composed of three steps S4-S6. It should be noted that the number and the length of the steps composing the first portion R1 may be optional according to characteristics of the golf shaft 3 and the like.

According to relatively reducing the number of the steps S4-S6 of the first portion R1, the steps S4-S6 are relatively long (by comparison with the steps of the second portion E1). This suppresses variation in the outer diameter of the first portion R1. Further, the steps S4-S6 are set relatively small in the difference between the axially adjacent steps in the outer diameter. This further suppresses the variation in the outer diameter of the first portion R1.

The present embodiment, therefore, ensures that a region of the first portion R1 having the thick wall thickness is long. The first portion R1 causes an upward projection in the distribution curve of the bending rigidity spanning from the tip end portion 9 to the butt end portion 11. With this, the first portion R1 forms the unbending portion b of the golf shaft 3. It should be noted that the projection shape in the distribution curve of the bending rigidity is based on a reference line L1. The reference line L1 is a straight line connecting a starting point of the first portion R1 and an end point of the second portion E1 in the distribution curve of the bending rigidity. In order to cause the upward projection in the distribution curve of the bending rigidity of the first portion R1, it is unnecessary to make the steps S4-S6 relatively long or reduce the number of the steps S4-S6.

The second portion E1 is located axially adjoining to the first portion R1 between the first portion R1 and the butt end portion 11 in the intermediate portion 13. The second portion E1 is formed smaller than the reducing trend of the intermediate portion 13 in the wall thickness and the steps in the second portion E1 are relatively axially short (by comparison with the steps of the first portion R1). According to the present embodiment, the second portion E1 is composed of one step S3. The number and the length of the steps composing the second portion E1 may be optional according to characteristics of the golf shaft 3 and the like.

The number of the steps S1-S3 of a portion spanning from the second portion E1 to a point just before the butt end portion 11 is the same as of the number of the steps of the first portion R1 or may be different from the number of the steps of the first portion R1. In the portion spanning from the second portion E1 to the point just before the butt end portion 11, the steps S1-S3 are shorter than the steps S4-S6 of the first portion R1 and increase variation in the outer diameter within an axial short range. Further, the difference in the outer diameter between axially adjacent steps of the steps S1-S3 is set relatively large (by comparison with the steps of the first portion R1). This further increases the variation in the outer diameter of the second portion E1. In addition, the difference in the outer diameter between the axially adjacent steps in the second portion E1 is the difference in the outer diameter between the step S3 mainly composing the second portion E1 and the steps S2 and S4 axially adjacent to the step S3 in this embodiment.

The present embodiment, therefore, causes a downward projection in the distribution curve of the bending rigidity spanning from the tip end portion 9 to the butt end portion 11 according to the combination of the setting of the wall thickness and the variation of the outer diameter in a region of the second portion E1 with the thin wall thickness. With this, the second portion E1 forms the bending portion a of the golf shaft 3. In addition, the steps S1 and S2 continuing to the butt end portion 11 form the unbending portion c of the golf shaft 3. In order to cause the downward projection in the distribution curve of the bending rigidity of the second portion E1, it is unnecessary to make the steps S1-S3 relatively short.

The projection shape in the distribution curve of the bending rigidity of the second portion E1 steeply transitions from the second portion E1 to the first portion R1 according to the setting of the outer diameter and the wall thickness, thereby relatively increasing the first portion R1 in the bending rigidity.

The third portion E2 is located axially adjoining to the first portion R1 between the first portion R1 and the tip end portion 9 in the intermediate portion 13. The third portion E2 is formed smaller than the reducing trend in the wall thickness in the intermediate portion 13 and the steps of the third portion E2 are relatively axially short (by comparison with the steps of the first portion R1). In addition, the number and the length of the steps composing the third portion E2 are optional according to characteristics of the golf shaft 3 and the like. Further, the size relation among the steps S1-S11 is expressed by S4=S5=S6>S1=S2>S7>S3=S8>S9=S10=S11 and is not limited thereto.

According to the present embodiment, the third portion E2 is composed of five steps S7-S11 and a part of straight portion 17. In addition, the number of the steps composing the third portion E2 may be optional according to characteristics of the golf shaft 3 and the like.

In the third portion E2, the steps S7-S11 are shorter than the steps S4-S6 of the first portion R1 and increase variation in the outer diameter within an axial short range. Further, the steps S7-S11 are set relatively large in a difference in the outer diameter between axially adjacent steps of the steps S7-S11 (by comparison with the steps of the first portion R1). This further increases the variation in the outer diameter of the third portion E2.

The present embodiment, therefore, causes a downward projection in the distribution curve of the bending rigidity spanning from the tip end portion 9 to the butt end portion 11 in a region of the third portion E2 with the thin wall thickness based on the combination of this setting of the wall thickness and the variation in the outer diameter. The third portion E2, therefore, forms the bending portion a of the golf shaft 3.

This projection shape in the distribution curve of the bending rigidity is based on a reference line L2. The reference line L2 is a straight line connecting an end point of the first portion R1 and a starting point of the third portion E2 in the distribution curve of the bending rigidity.

The projection shape in the distribution curve of the bending rigidity of the third portion E2 steeply transitions from the third portion E2 to the first portion R1 according to the setting of the outer diameter and the wall thickness, thereby relatively increasing the first portion R1 in the bending rigidity. In addition, the projection shape in the distribution curve of the bending rigidity of the third portion E2 includes a flat portion F in the distribution curve of the bending rigidity, the flat portion transitioning with a fixed value in the bending rigidity toward the butt end portion 11.

The golf shaft 3 of the present embodiment includes a fourth portion R2. The fourth portion R2 is located axially adjoining to the third portion E2 in the tip end portion 9. The fourth portion R2 corresponds to the tapered portion 19 and the part of the straight portion 17 in the tip end portion 9.

Bending rigidity of the fourth portion R2 is greater than the bending rigidity of the flat portion F of the third portion E2. According to the present embodiment, the distribution curve of the bending rigidity of the fourth portion R2 causes an upward projection. This projection shape of the distribution curve of the bending rigidity is based on a reference line L3. The reference line L3 is a straight line connecting a starting point of the fourth portion R2 and an end point of the third portion E2 in the distribution curve of the bending rigidity.

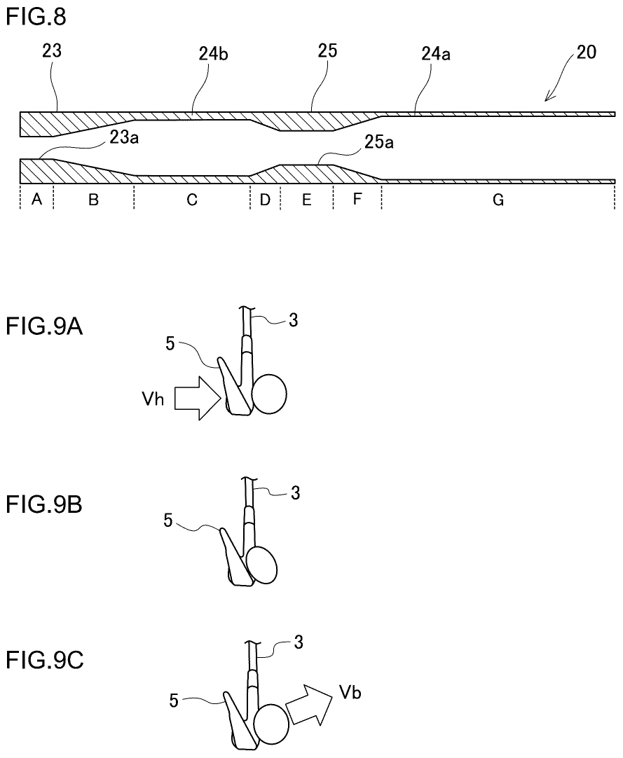

FIG. 8 illustrates an element tube subjected to the thickness deviation process in a method of manufacturing the golf shaft according to the embodiment. The golf shaft 3 of FIG. 2 is manufactured through a stepping process performed to the element tube 20 to which the thickness deviation process in FIG. 8 is performed.

The thickness deviation process forms thick portions 23a and 25a on a tip end portion 23 and an intermediate portion 25 of the element tube 20 made of metal, in particular steel and thin portions 24a and 24b axially adjoining to the thick portion 25a. The tip end portion 23 of the element tube 20 corresponds to the tip end portion 9 of the golf shaft 3 and the intermediate portion 25 of the element tube 20 corresponds to the intermediate portion 13 of the golf shaft 3. In addition, material of the element tube 20 may be metal other than steel.

Particularly, the thick portion 23a is formed on a A-part and a B-part of the element tube 20 corresponding to the insertion portion 8 and the tapered portion 19 of the tip end portion 9 of the golf shaft 3 and the thick portion 25a is formed on a D-part, a E-part and a F-part corresponding to the first portion R1 of the intermediate portion 13. The B-part, the D-part and the F-part have an inner periphery formed into a tapered shape.

A C-part and a G-part of the element tube 20 corresponding to the third portion E2 and the second portion E1 of the golf shaft 3 are the thin portions 24a and 24b formed thin in the wall thickness, respectively. In addition, the C-part and the G-part are straight tubes and the C-part is thicker than the G-part in the wall thickness.

The thickness deviation process is, therefore, performed to the element tube 20 made of metal so that the intermediate portion 25 of the element tube 20 has the thick portion 25a corresponding to the first portion R1 and the thin portions 24a and 24b corresponding to the second portion E1 and the third portion E2 axially adjoining to the thick portion 25a on both axial sides of the thick portion 25a. Further, the thin portion 24a on a side close to a portion (being the tip end portion 23 of the element tube 20) corresponding to the tip end portion 9 of the golf shaft 3 is thicker than the thin portion 24b on a side close to a portion (being the butt end portion of the element tube 20) corresponding to the butt end portion 11 of the golf shaft 3.

The present invention performs the stepping process to the element tube 20 to which the thickness deviation process is performed, i.e. the element tube 20 having the thick portion 25a and the thin portion 24a and 24b according to the wall thickness as illustrated in FIG. 3, thereby obtaining the distribution curve of the bending rigidity as illustrated in FIG. 5.

Namely, the stepping process forms the steps S1-S11 gradually increasing in the outer diameter from the front end to the base end of the intermediate portion 25 of the element tube 20 so that the steps S4-S6 at the thick portion 25a are relatively long and the steps S1-S3 and S7-S11 at the thin portions 24a and 24b are relatively shot. At this time, the present embodiment makes the difference in the outer diameter between each of the steps S1-S3 and S7-S11 and the steps axially adjoining to each of the steps S1-S3 and S7-S11 relatively large at the thin portions 24a and 24b. In this way, the golf shaft 3 is manufactured.

The stepping process is, therefore, performed to the element tube 20 to which the thickness deviation process is performed to form the golf shaft 3 having the intermediate portion 13 defined between the respective ends axially adjoining to the tip end portion 9 and the butt end portion 11, the intermediate portion 13 of the golf shaft 3having the steps S1-S11 gradually increasing in the outer diameter from the end adjoining to the tip end portion 9 to the end adjoining to the butt end portion 11 and sectioned into the first portion R1, the second portion E1 and the third portion E2 according to the thick portion 25a and the thin portions 24a and 24b of the element tube 20.

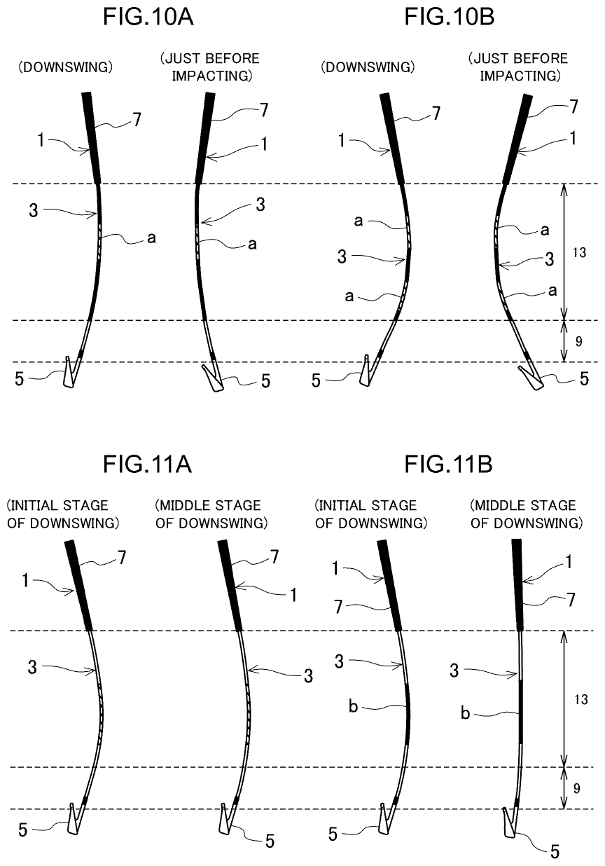

FIG. 9A is a side view illustrating the head and periphery thereof just before impacting a ball, FIG. 9B is a side view illustrating the same at the time of the impacting and FIG. 9C is a side view illustrating the same just after the impacting. FIG. 10A is a side view illustrating a golf club according to a comparative example having one bending portion at the time of a downswing and just before impacting a ball and FIG. 10B is a side view illustrating a golf club having two bending portions at the time of a downswing and just before impacting a ball.

A head 5 exhibits head speed Vh just before impacting a ball as FIG. 9A, impacts the ball as FIG. 9B and comes to a state just after the impacting as FIG. 9C. Speed of the hit ball (ball speed) is Vb just after the impacting as FIG. 9C.

In a golf swing, a golf shaft 3 is bent in a direction opposite to a direction of a club face at the time of a downswing and is bent in the direction of the club face just before impacting the ball as illustrated in FIGS. 10A and 10B.

As illustrated in FIG. 10A, a golf club 1 having one bending portion a in an intermediate portion 13 is bent with a small bending amount at the time of a downswing and just before impacting. In contrast, as illustrated in FIG. 10B, a golf club 1 having two bending portions a in an intermediate portion 13 is bent with a large bending amount at the time of a downswing and just before impacting.

The golf club 1 with the two bending portions a, therefore, increases in a moving distance of a head 5 during a fixed time period and accordingly in head speed Vh just before the impacting. This results in increase of the ball speed Vb.

FIG. 11A is a side view illustrating a golf club with no hardened portion in an intermediate portion at an initial stage and a middle stage of a downswing and FIG. 11B is a side view illustrating a golf club with a hardened portion in an intermediate portion at an initial stage and a middle stage of a downswing.

As illustrated in FIG. 11A, a golf club 1 with no hardened portion in an intermediate portion 13 delays to restore in the middle stage of the downswing from bending that is in the initial stage of the downswing. In contrast, a golf club 1 with a hardened portion in an intermediate portion 13 quickly restores in the middle stage of the downswing from bending that is in the initial stage of the downswing as illustrated in FIG. 11B.

The golf club 1 with the hardened portion in the intermediate portion 13, therefore, increases in a moving distance of a head 5 during a fixed time period and this results in increase in ball speed Vb and in head speed Vh.

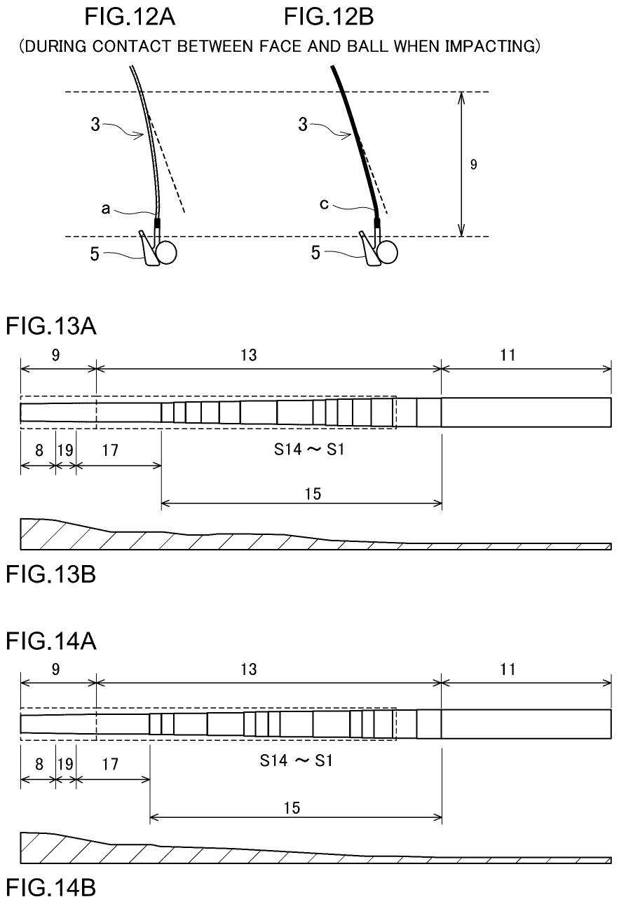

FIG. 12A is a side view illustrating a golf club with a soft tip end portion at the time of impacting a ball and FIG. 12B is a side view illustrating a golf club with a hard tip end portion at the time of impacting a ball.

As illustrated in FIG. 12A, a golf club 1 with a soft tip end portion 9 stores energy based on bending of an intermediate portion 13 and wastes the stored energy to deform a tip end portion 9 during contact between a face and a ball. In contrast, a golf club 1 with a hard tip end portion 9 is suppressed from waste of energy stored on the basis of bending of an intermediate portion 13 for deformation of the tip end portion 9 as illustrated in FIG. 12B.

The golf club 1 with the hard tip end portion 9, therefore, increases in energy transmitted to a hit ball and in the ball speed Vb.

The golf shaft 3 of the present embodiment has the first portion R1 that is the unbending portion b and the second and the third portions E1 and E2 that are the bending portions a on both axial sides of the first portion R1 in the intermediate portion 13. The golf shaft 3, therefore, increases in bending at the time of the downswing and just before impacting the ball and quickly restores in the middle stage of the downswing from the bending. At this result, the golf shaft 3 increases in ball speed Vb and head speed Vh.

Additionally, the golf shaft 3 of the present embodiment causes the projection shapes of the second portion E1 and the third portion E2 in the distribution curve of the bending rigidity to steeply transition from the second portion E1 and the third portion E2 to the first portion R1 in bending rigidity according to the setting of the outer diameter and the wall thickness.

This results in relatively enhancing the bending rigidity at the first portion R1 and making the second portion E1 and the third portion E2 easy to bend from regions of the second portion E1 and the third portion E2 proximal to the first portion R1. With this, the golf shaft 3 of the present embodiment further surely increases in the bending at the time of the downswing and just before impacting the ball and further quickly restores in the middle stage of the downswing from the bending.

Moreover, the golf shaft 3 of the present embodiment has the fourth portion R2 that is the unbending portion c in the tip end portion 9, so that the tip end portion 9 is suppressed from bending during impacting the ball with the face to increase in energy transfer and in ball speed Vb.

Samples 1-4 were made for the golf shaft 3 of the present embodiment based on the aforementioned mechanism and trial hitting was conducted using each of the samples 1-4.

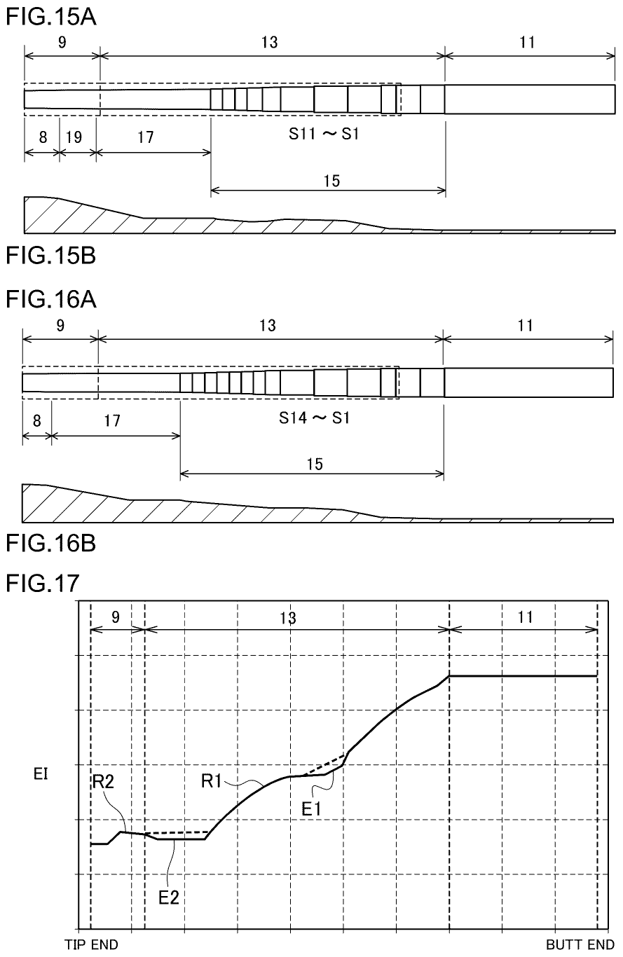

FIG. 13A, FIG. 14A, FIG. 15A and FIG. 16A are side views illustrating samples 1-4 of the golf shaft according to the embodiment, respectively. FIG. 13B, FIG. 14B, FIG. 15B and FIG. 16B are sectional views illustrating wall thickness of the samples 1-4 of the same, respectively. FIG. 17-FIG. 20 are graphs illustrating distribution curves of the bending rigidity of the samples 1-4, respectively.

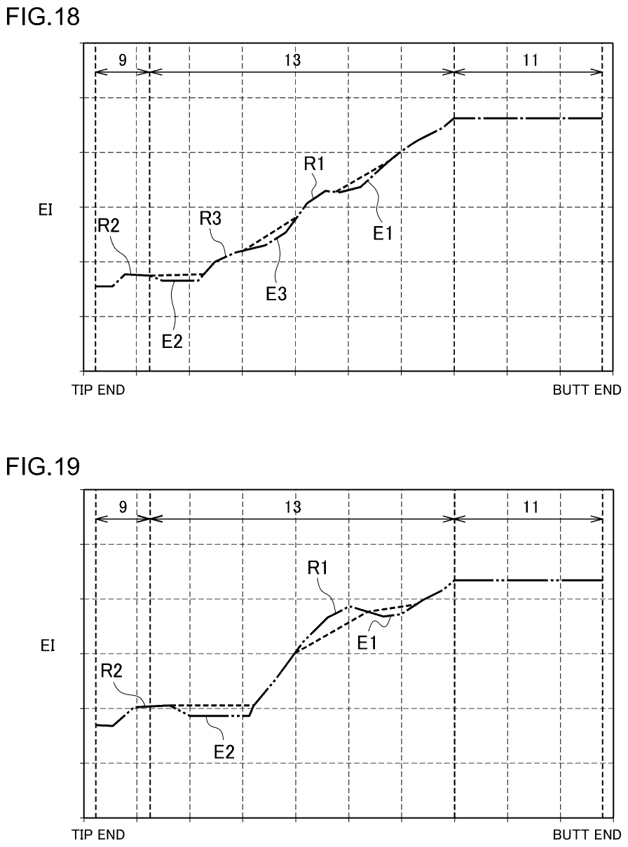

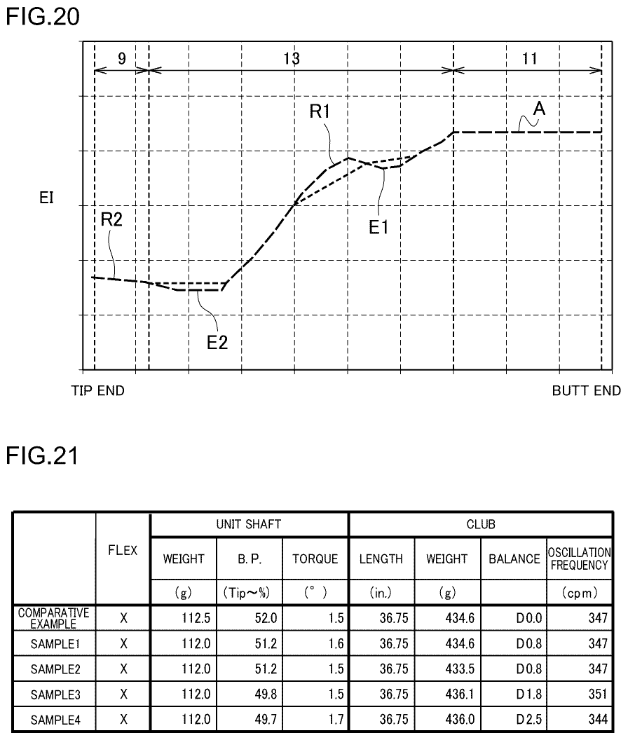

In the samples 1-4 of the FIG. 13A-FIG. 16B, the intermediate portions 13 of the sample 1of FIG. 13, the sample 3 of FIG. 15 and the sample 4 of FIG. 16 each have one unbending portion (first portion R1) and two bending portions (second and third portions E1 and E2) as illustrated in FIG. 17, FIG. 19 and FIG. 20. In contrast, the intermediate portion 13 of the sample 2 of FIG. 14 has two unbending portions (first portion R1 and fifth portion R3) and three bending portions (second, third and sixth portions E1, E2 and E3) as illustrated in FIG. 18.

In the sample 1, the first portion R1, the second portion E1 and the third portion E3 are close to the tip end portion 9 relative to the embodiment. In response to this, the fourth portion R2 is close to the tip end of the tip end portion 9 relative to the embodiment. Further, the sample 1 causes the projection shape of the first portion R1 smaller than that of the embodiment in the distribution curve of the bending rigidity. Others are the same as of the embodiment.

In the sample 2, the first portion R1, the second portion E1 and the third portion E3 are close to the tip end portion 9 relative to the embodiment and the fifth portion R3 and the sixth portion E3 are arranged between the first portion R1 and the third portion E2.

The sample 2 causes the projection shape of the first portion R1 smaller than that of the embodiment in the distribution curve of the bending rigidity. The fifth portion R3 causes an upward projection on the same level with the first portion R1 in the distribution curve of the bending rigidity, and the sixth portion E3 causes a downward projection on the same level with the second portion E1 in the distribution curve of the bending rigidity. Others are the same as of the embodiment.

In the sample 2, the first portion R1, the second portion E1, the third portion E2, the fourth portion R2, the fifth portion R3 and the sixth portion E3 have approximately the same length and are shorter than those of the embodiment, respectively.

The sample 3 is the same configuration as the embodiment with slight difference in the number of the steps and the distribution curve of the bending rigidity.

The sample 4 softens the tip end portion 9 relatively to the sample 3. The distribution curve of the bending rigidity of the sample 4 is similar to the distribution curve of the bending rigidity of the sample 3.

The sample 4 has inclinations between the third portion E2 and the fourth portion R2 axially adjacent to each other and between the third portion E2 and the first portion R1 axially adjacent to each other in the distribution curve of the bending rigidity of the sample4 are set gentler than those of the sample 3.

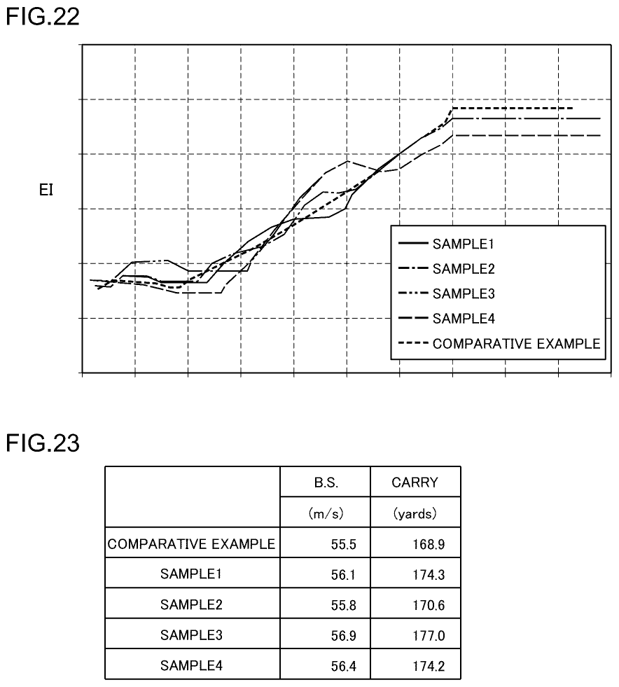

FIG. 21 is a graph and a table illustrating specifications of the samples of the golf shafts according to the embodiment and the comparative example. FIG. 22 is a graph illustrating the distribution curves of the bending rigidity of the golf shafts according to the embodiment and the comparative example.

A trial hitting test is conducted for the samples 1-4 and the comparative example. The samples 1-4 are configured as mentioned above and the comparative example is configured such that the wall thickness is reduced as increase in the outer diameter as illustrated by dot lines in FIGS. 4 and 6. In this comparative example, there is no upward and downward projections in the distribution curve of the bending rigidity as illustrated in FIG. 22. Further, the distribution curves of the bending rigidity at the fourth portions R2 in the samples 1-3 are higher than the distribution curve of the bending rigidity at the tip end portion 9 in the comparative example.

As illustrated in FIG. 21, specifications of the samples 1-4 and the sample of the comparative example are for, for example, a 7th iron and are fixed in flex and length. Others such as weight, B.P. (balance point), torque, total weight and oscillation frequency are varied according to settings of the samples 1-4 and the sample of the comparative example in the outer diameter and the thickness.

The trial hitting test is conducted by a robot using each of the samples 1-4 and the sample of the comparative example to which the head 5 is attached. A position of a ball is on an extension of a robot center and a direction of a face is orthogonal to a target direction.

The heads 5 in the samples 1-4 and the comparative example have the same specification and are used for all the trial hittings and a hitting spot in each of the heads 5 is a center of gravity thereof. The number of the trial hittings are 10 for each of the samples 1-4 and the comparative example.

The robot is set so that head speed of the sample of the comparative example is 40 m/s as target head speed and conducts, using this setting, the trial hittings to all the samples 1-4 and the sample of the comparative example.

FIG. 23 is a table illustrating results of the trial hittings using the samples of the golf shafts according to the embodiment and the comparative example. In FIG. 23, values of B.P. (ball speed) and carry are indicated as the trial hitting results.

The ball speed of the comparative example is Vb=55 m/s and the carry thereof is 168.9 yard. In contrast, the samples 1-4 exhibit the ball speeds and the carries exceeding those of the comparative example.

In particular, the sample 3 exhibits the ball speed Vb being 56.9 m/s and the carry being 177.0 yard and exceeds the comparative example by 1.4 m/s in ball speed Vb and 8.1 yards in carry.

What is claimed is:

1. A golf shat comprising:
a tip end portion for attaching a head thereto;
a butt end portion for attaching a grip thereto;
an intermediate portion defined between respective ends of the intermediate portion axially adjoining to the tip end portion and the butt end portion, having steps gradually increasing in an outer diameter from the end adjoining to the tip end portion to the end adjoining to the butt end portion and having wall thickness gradually reduced according to the increasing in the outer diameter of the steps, wherein
the intermediate portion is sectioned into a first portion and a second portion,
the first portion is formed greater than a reducing trend of the intermediate portion in the wall thickness to cause an upward projection in a distribution curve of a bending rigidity, the distribution curve of the bending rigidity spanning from the tip end portion to the butt end portion, and
the second portion is located axially adjoining to the first portion between the first portion and the butt end portion and is formed smaller than the reducing trend in the wall thickness to cause a downward projection in the distribution curve of the bending rigidity.

2. The golf shat according to claim 1 wherein
a step of the second portion is axially shorter than a step of the first portion.

3. The golf shat according to claim 1 wherein
a difference in the outer diameter between axially adjacent steps in the first portion is smaller than a difference in the outer diameter between axially adjacent steps in the second portion.

4. The golf shat according to claim 1 wherein
the intermediate portion has a third portion sectioned so as to be located axially adjoining to the first portion between the first portion and the tip end portion and be formed smaller than the reducing trend in the wall thickness to cause a downward projection in the distribution curve of the bending rigidity.

5. The golf shat according to claim 4 wherein
a step of the third portion is axially shorter than a step of the first portion.

6. The golf shat according to claim 4 wherein
the third portion causes a flat portion in the distribution curve of the bending rigidity, the flat portion transitioning with a fixed value in the bending rigidity toward the butt end portion.

7. The golf shat according to claim 4 further comprising:
a fourth portion located on a side close to the tip end portion relative to the third portion and being greater than the third portion in the bending rigidity.

8. A method of manufacturing a golf shaft, comprising:
performing a thickness deviation process to an element tube made of metal so that an intermediate portion of the element tube has a thick portion and thin portions on both axial sides of the thick portion; and
performing a stepping process to the element tube having the thick portion and the thin portions according to the wall thickness, thereby forming steps gradually increasing in the outer diameter from.

9. The method of manufacturing the golf shat according to claim 8 wherein
the stepping process makes the steps at the thick portion relatively axially long and the steps at the thin portions relatively axially short.
